(19) United States
(12) Patent Application Publication
(10) Pub. No.: US 2007/0027581 A1
(43) Pub. Date: Feb. 1, 2007

(54) Control system for a tractor trailer

(75) Inventors: Wolf-Dietrich Bauer, Leinfelden-Echterdingen (DE); Christian Mayer, Reutlingen (DE); Andreas Schwarzhaupt, Landau (DE); Gernot Spiegelberg, Heimsheim (DE)

Correspondence Address: CROWELL & MORING LLP;INTELLECTUAL PROPERTY GROUP, P.O. BOX 14300, WASHINGTON, DC, 20044-4300, US

(73) Assignee: DaimerlerChrysler AG, Stuttgart (DE)

(21) Appl. No.: 10/546,782

(22) PCT Filed: Feb. 23, 2005
(86) PCT No.: PCT/EP05/01870

§ 371 Date: Sep. 20, 2006

(30) Foreign Application Priority Data
Feb. 25, 2004 (DE) 10 2004 009 187.0

(51) Int. Cl. G05D 1/00; G06F 17/00

(52) U.S. Cl. 701/1; 701/41

(57) ABSTRACT

The present invention relates to a control system (7) for a vehicle combination composed of a towing vehicle and a trailer for picking up, transporting and setting down a frame which can be positioned on supports and have a payload loaded onto it, wherein a path computer (8) is provided which calculates a path which, in order to pick up the frame (4) calculates a path which leads the trailer backward under the frame.

A particularly reliable system is obtained if a first input device (10) is provided, by means of which an actual position and an actual orientation of the frame can be input into the path computer (8), and if a second input device (11) is provided by means of which an actual position and an actual orientation of the trailer can be input into the path computer (8). The path computer (8) is then configured in such a way that it calculates, from the actual position and the actual orientation of the frame, a reference position and a reference orientation for the trailer in which the trailer is located under the frame in order to pick it up, and in that said path computer (8) calculates, from the actual values and the reference values of the position and orientation of the trailer, the path which leads the trailer backward under the frame.

The present invention relates to a control system for a vehicle combination composed of a towing vehicle and a trailer having the features of the preamble of claim 1.

DE 195 26 702 A1 discloses a control system for a vehicle combination composed of a towing vehicle and a trailer for picking up, transporting and setting down a frame which can be positioned on supports and have a payload loaded onto it, said control system having a path computer which, in order to pick up the frame, calculates a path which leads the trailer backward under the frame. For this purpose, the known control device operates with a camera which is arranged at the rear of the trailer and which detects the frame for a corresponding relative orientation between the vehicle combination and frame. In this context, a distance between the frame and the trailer and an angle between a frame longitudinal axis and a trailer longitudinal axis are determined. The path which leads the trailer under the frame during the reverse movement can then be calculated from this distance and this angle.

In the known control system, a state controller determines path reference values from the calculated path and associated steering angle reference values from said path reference values. The steering angles can then be set automatically at a steering system of the vehicle using a corresponding servomechanism.

The picking up of a frame from the trailer of a vehicle combination can be considerably simplified using such a control system since the reverse movement of a vehicle combination requires an experienced vehicle driver and generally a person giving directions owing to the complex kinematics unless there is such a control system.

DE 100 32 179 A1 discloses another control system in which the vehicle is equipped with a drive train which can be actuated electronically. This drive train comprises at least a steering system, a brake system and a drive assembly. Such control systems for vehicles with a drive train which can be actuated electronically are also referred to as drive-by-wire systems or as X-by-wire systems. With such systems it is possible to control a steering system, brake system and drive assembly of the vehicle electronically without there being a continuous mechanical or hydraulic connection between the corresponding operator control elements such as the steering wheel, brake pedal and accelerator pedal, and the respective drive train component. The associated control system comprises an operator control device which is fixed to the vehicle and into which a vehicle driver inputs a driving request via corresponding operator control elements such as the steering wheel, brake pedal, accelerator pedal, and which generates a standardized movement vector from the driving request. This movement vector corresponds here, for example, to a bus protocol, in particular a CAN protocol. This operator control device thus forms an input level for predefined values (driving requests) which are to be processed by the drive train. Furthermore, a control device is then also provided and said control device generates, from an input-end movement vector, control signals at the output end in order to actuate the drive train. These control signals are then transferred to the drive train and processed by it in order to implement the driving request. This control device thus forms a coordination level which permits the standardized reference signals (driving request) to be implanted at the drive train.

The present invention is concerned with the problem of specifying, for a control system of the type mentioned at the beginning, a different embodiment which operates particularly reliably and can have an additional functionality.

This problem is solved according to the invention by means of the subject matter of the independent claim. Advantageous embodiments are the subject matter of the dependent claims.

The present invention is based on the general idea of acquiring reference values for the position and orientation of the trailer from actual values for the position and orientation of the frame in order to calculate, by comparing the reference values and actual values for the orientation and position of the trailer, the necessary path which makes it possible to move the trailer from its actual position and actual orientation into the calculated reference position and reference orientation in which the trailer is then located underneath the frame and can pick it up.

By virtue of the precision with which the actual values of the orientation and position for the trailer and for the frame can be made available and/or read into the control system, it is possible to improve a satisfactory method of functioning of the control system and thus of the picking up process for the frame. The control system according to the invention is basically independent of the visual quality and adjustment of a camera or of current visibility conditions.

A development in which the actual values for the position and orientation of the frame are stored electronically in a memory of the frame in such a way that they can be read out is particularly advantageous, and in this case a first input device by means of which an actual position and an actual orientation of the frame can be input into the path computer, or a central memory of a dispatching center or logistics center can be connected to this frame memory in order to transmit data. In this way, the required actual values for the position and orientation of the frame are assigned precisely to the respective frame. The electronic or digital storage of the required frame actual values avoids input errors during corresponding electronic data transmission, which increases the functional reliability of the control system. Furthermore, the actual values can, as it were, be stored with any desired high level of accuracy, which also improves the functional capability of the control system.

According to one development, the frame memory can be permanently arranged on the frame, in which case the first input device and/or the central memory can then be connected to the frame memory to form a telemetric data transmission means. This is a particularly convenient solution which permits particularly simple and reliable transmission of data between the frame memory and the path computer. Alternatively, the frame memory can also be arranged in a removable fashion on the frame, in which case the first input device and/or the central memory is then equipped with a suitable interface via which the frame memory can be connected to the first input device or to the central memory in order to transmit data. In this more cost effective embodiment it is also possible to transmit data reliably and securely.

Further important features and advantages of the invention emerge from the subclaims, from the drawings and from the associated description of the figures with reference to the drawings.

Of course, the features which are mentioned above and the features which are still to be explained below can be used not only in the respectively specified combination but also in other combinations or independently without departing from the scope of the present invention.

Preferred exemplary embodiments of the invention are illustrated in the drawings and will be explained in more detail in the following description in which identical reference symbols relate to identical or functionally identical or similar components.

In said drawings,

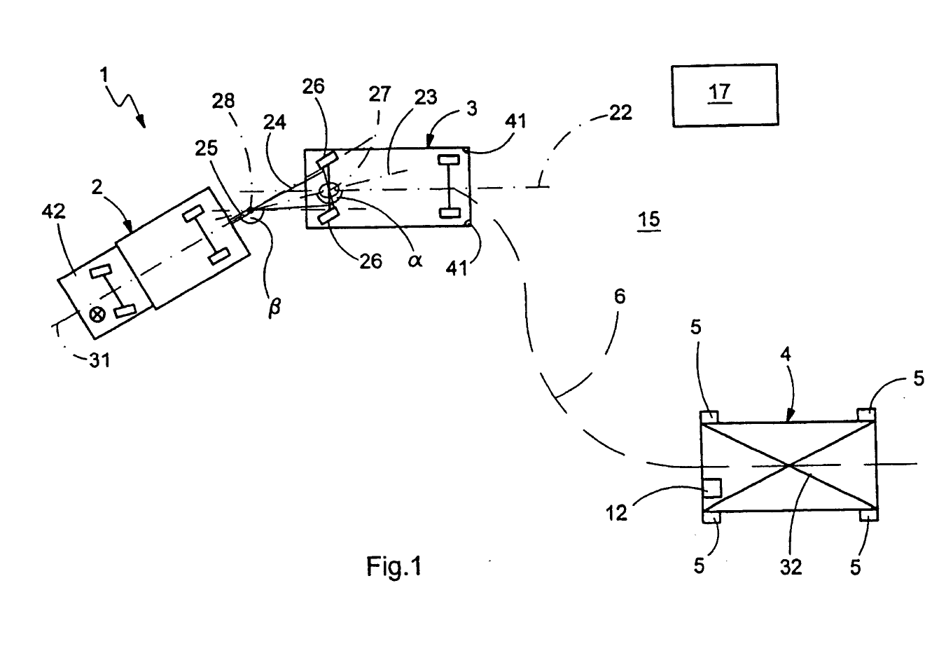

FIG. 1 is a schematic, highly simplified plan view of a vehicle combination when a frame is picked up, and

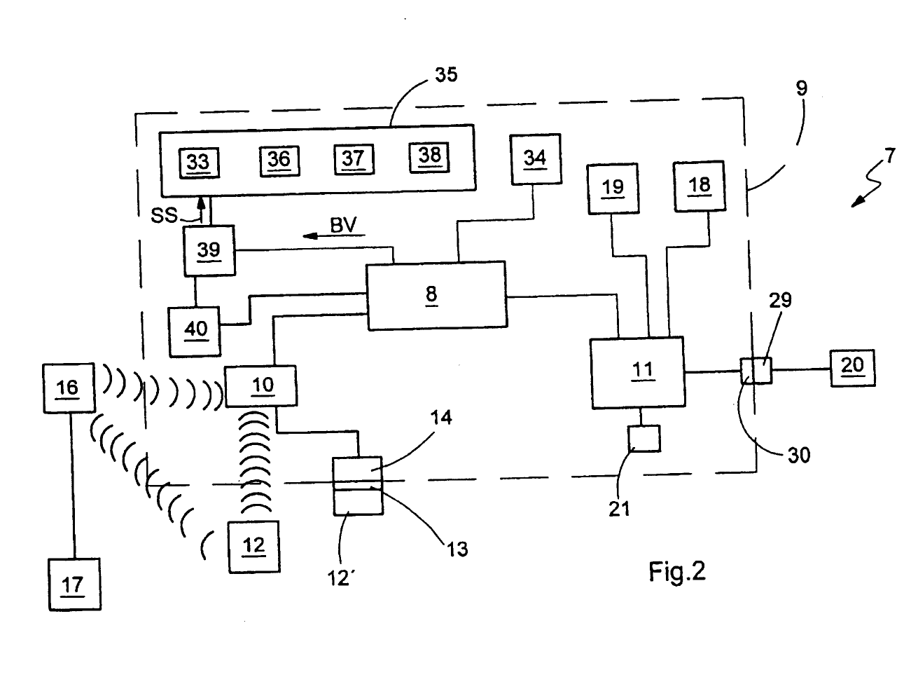

FIG. 2 is a schematic, circuit diagram-like basic illustration of the control system according to the invention.

According to FIG. 1, a vehicle combination 1 has a towing vehicle 2 and a trailer 3 which is designed to pick up, transport and set down a frame 4, and such a frame 4 has supports 5, on which it can be positioned, and a payload 32, for example a container, can be loaded onto said frame 4.

In order to set down the frame 4, the supports 5 are extended and the frame 4 is raised relative to the trailer 3. It is also basically possible to lower the trailer 3 relative to the frame 4. The trailer 3 can then be moved away from under the frame 4. In order to pick up the frame 4, the trailer 3 must accordingly be moved backward again under the frame 4. To do this, the trailer 3 must travel in reverse along a suitable path 6 which is indicated here by a broken line, which can be manually implemented only with relative difficulty with such a vehicle combination 1 owing to the prevailing complex kinematics, and is generally very time consuming and also may require a person giving directions.

According to FIGS. 1 and 2, a control system 7 according to the invention comprises a path computer 8 which is fixed to the vehicle and which can be used to calculate the previously mentioned path 6. The components of the control system 7 which are fixed to the vehicle are arranged here in a frame which is indicated by a broken line and designated by 9. Accordingly, the control system 7 also comprises a first input device 10 which is fixed to the vehicle and is configured in such a way that it can be used to input an actual position and an actual orientation of the frame 4 into the path computer 8. Furthermore, a second input device 11 which is fixed to the vehicle is also provided, said input device 11 being configured in such a way that it can be used to input an actual position and an actual orientation of the trailer 3 into the path computer 8.

In the present context, “orientation” and “position” are differentiated. Firstly, the “position” of the towing vehicle 2, of the trailer 3 or of the frame 4 determines the relative position of a predetermined reference point of the towing vehicle 2, of the trailer 3 or of the frame 4 within a geostationary reference coordinate system which is generally defined using longitude and latitude coordinates. In contrast to this, the term “orientation” designates the orientation of a longitudinal axis of the towing vehicle 2, of the trailer 3 or of the frame 4 within the respective reference coordinate system. The points of the compass can be used to describe the orientation, for example.

According to the invention, the path computer 8 is configured in such a way that it firstly calculates a reference position and a reference orientation for the trailer 3 from the actual position and the actual orientation of the frame 4, in which case these reference values for the position and orientation of the trailer 3 are selected in such a way that in order to pick up the frame 4 the trailer 3 is located under the frame 4 with a relative orientation which is suitable for this purpose.

The path computer 8 is also programmed or equipped in such a way that it can subsequently calculate, from the actual values and the reference values for the position and orientation of the trailer 3, the previously mentioned path 6 which leads the trailer 3 under the frame 4 during the reverse movement of the vehicle combination 1.

According to one particularly advantageous embodiment, the frame 4 has a memory or frame memory 12. The required actual values for the position and orientation of the frame 4 are stored electronically in this frame memory 12 in such a way that this data can be read out of the frame memory 12 depending on requirements. The first input device 10 can then be suitably connected to this frame memory 12 in such a way that data transmission can take place. The actual values for the position and orientation of the frame 4 can then pass from the frame memory 12 to the path computer 8 via the first input device 10. An embodiment in which the transmission of data between the frame memory 12 and the first input device 10 operates telemetrically is preferred here. In such an embodiment, the frame memory 12 is permanently mounted on the frame 4. Depending on the configuration of the frame memory 12, it does not require a separate voltage supply for the telemetric transmission of data. It is clear that for the telemetric transmission of data a suitable transceiver arrangement (not shown here in more detail) is provided, said transceiver arrangement permitting the wirefree transmission of data between the frame memory 12 and the first input device 10.

In addition or alternatively there may also be provision for the frame memory 12 to be attached to the frame 4 in such a way that it can be lifted off or removed from it. The removable frame memory, referred to below by 12′, then has a corresponding interface 13 and can be placed in contact with a complementary interface 14 which is arranged fixed to the vehicle and is connected to the first input device 10.

Furthermore, it is basically also possible to connect the frame memory 12 which is fixed to the frame to the first input device 10 via a corresponding connecting line. Such a line may, for example, connect the interfaces 13 and 14 to one another and thus permit wirebound transmission of data.

According to FIG. 1, the frame 4 can be positioned, for example, on the premises 15 of a dispatching center or logistics center (not illustrated otherwise). According to FIG. 2, this logistics center can have a central memory 16 which can also be connected to the frame memory 12 in order to transmit data. Telemetric transmission of data and a connection via a module location or via a wirebound connection are also possible here.

The actual positions and actual orientations for all the frames 4 which are located on the premises 15 of the dispatching center at a particular time are then expediently stored in the central memory 16. In one development, the actual values for the orientation and position of the frame 4 which is to be respectively picked up can then be obtained directly from the central memory 16 by the first input device 10, and telemetric transmission of data is also conceivable here. Alternatively it is also possible for wirebound transmission of data to take place here.

It may be expedient in this context to store additional information, for example freight information, in the frame memory 12. Such freight information such as, for example the type of cargo, destination of the cargo and delivery deadlines for the cargo, may, on the one hand, be significant for the logistic center. On the other hand, it can also be of interest to the driver of the vehicle combination 1. It is conceivable, for example, to couple a vehicle-internal navigation system in such a way that inputting the destination for said system automatically transfers the destination of the cargo and calculates the route for the vehicle combination 1 therefrom.

In order to determine the actual position of the frame 4, the frame 4 can be equipped, for example, with a satellite-supported position determining device. In order to determine its actual orientation, the frame 4 can be equipped, for example, with a compass which can be read out. This orientation determining device and the position determining device can then read the actual values for the orientation and position into the frame memory 12. Alternatively, the respective dispatching center can be equipped with a central position and orientation determining device 17 which makes it possible to determine the current orientation and position for each frame 4 which is located on the premises 15 of the dispatching center. For example, such an orientation and position determining device can operate with cameras and/or with radar and/or with sonar. As soon as the respective frame 4 is positioned on the premises 15, the position and orientation determining device 17 can determine the respective orientation and position of the frame 4 and transmit the associated actual values to the central memory 16.

The second input device 11 can be connected to a satellite-supported navigation device 18 and to at least one compass 19 which can be read out. The navigation device 18, generally a GPS, and the compass 19 which can be read out are arranged fixed to the vehicle here, in particular fixed to the towing vehicle. In the case of a compass 19 which is fixed to the trailer, the actual orientation of the trailer 3 may be determined particularly easily as a function of the actual position of the towing vehicle 2 from the geometry of the trailer 3 and of the towing vehicle 2 in the case of a navigation device 18 which is fixed to the towing vehicle. However, the process of determining the position of the trailer 3 is made simpler by a navigation system 18 which is fixed to the trailer. However, since this is relatively costly and the towing vehicle 2 is generally equipped in any case with a navigation system 18 which is fixed to the towing vehicle and with a compass 19 which is fixed to the towing vehicle, the second input device 11 preferably operates with a bending angle sensor 20 and/or with a shaft angle sensor 21.

With reference to FIG. 1, it is possible to use the bending angle sensor 20 to determine a bending angle α which occurs between a trailer longitudinal axis 22 and a shaft longitudinal axis 23. The trailer 3 is connected here to a trailer hitch 25 of the towing vehicle 2 via a shaft 24. The shaft 24 is used to carry out steering activation operations of the steerable wheels 26 of the trailer 3. The shaft longitudinal axis 23 extends through a rotational axis 27 between the shaft 24 and trailer 3 and through a rotational axis 28 between the shaft 24 and trailer hitch 25. The bending angle sensor 20 is preferably mounted on the trailer 3 here and can communicate with the second input device 11 of the towing vehicle 2 via corresponding interfaces 29 and 30. In contrast to this, the shaft angle sensor 21 is used to measure a shaft angle β which occurs between the shaft longitudinal axis 23 and a towing vehicle longitudinal axis 31. The shaft angle sensor 21 is expediently installed on the towing vehicle 2, which simplifies the data-transmitting connection to the second input device 11.

When there is a trailer 3 which is configured as a semitrailer, it is possible to dispense with one of the angle sensors 20, 21 since such a semitrailer does not have any shaft so that the bending angle can be measured directly there between the trailer longitudinal axis 22 and the towing vehicle longitudinal axis 31.

The same also then applies to a trailer which is permanently connected to a rigid shaft and has only one axle, which may, for example, also be a double axle or a twin axle. With such a trailer 3 it is also the case that only one sensor has to be provided to determine the angle between the trailer longitudinal axis 22 and the towing vehicle longitudinal axis 31.

The path computer 8 can thus determine the actual orientation and actual position of the trailer 3 from the actual orientation and actual position of the towing vehicle 2 by means of the data of the navigation system 18, of the compass 19 and of the angle sensors 20, 21.

In one particularly advantageous embodiment, when the frame 4 is positioned the path computer 8 can transform the actual values which are known to it for the orientation and position of the trailer 3 into actual values for the orientation and position of the frame 4. As a rule, these actual values will approximately correspond so that this transformation is relatively easy. Furthermore, the path computer 8 may be set in such a way that it reads in the acquired actual values for the orientation and position of the frame 4 into the frame memory 12 during the positioning process, for example during or after the extension of the supports 5.

If, in another embodiment, the dispatching center is equipped with the position determining and orientation determining device 17, said device 17 can also determine and make available the actual values for the orientation and position of the towing vehicle 2 and/or of the trailer 3. The actual values which are made available in this way can be called, for example at the central processor unit 16, by the second input device 11 in a wirebound or wirefree fashion. In such an embodiment, the vehicle combination 1 does not require a separate navigation device 18 or a separate compass 19.

The path computer 8 expediently generates the path 6 in such a way that it is composed of a sequence of movement vectors BV. These movement vectors BV comprise at least one steering instruction for a steering system 33 of the towing vehicle 2. The path computer 8 determines the steering instructions here in such a way that during the reverse movement of the vehicle combination 1 and when following the aforesaid steering instructions the trailer 3 follows the path 6 and thus moves under the frame 4.

In one simple embodiment, the control system 7 according to the invention can have a display device 34 which is arranged in a cockpit 42 of the vehicle. This display device 34 is configured in such a way that it displays the current steering instruction of the movement vector BV to the driver of the vehicle in a visual and/or audible fashion. The driver of the vehicle must then simply follow the displayed steering instructions during the reverse movement in order to move the trailer 3 of his vehicle combination 1 under the frame 4 without difficulty. This variant of the control system 7 can in particular also be retrofitted into a conventional vehicle.

A modern towing vehicle 2 can be equipped with a drive train 35 which can be actuated electronically. This drive train 35 comprises at least one steering system 33 which can be activated electronically. In the exemplary embodiment shown here, the drive train 35 also comprises a brake system 36 which can be activated electronically and a drive assembly 37 which can be activated electronically. Furthermore, a gearbox 38 which can be activated electronically can also be provided.

Moreover, such a towing vehicle 2 comprises a control device 39 for activating the drive train 35 or the components of this drive train 35. The control device 39 is configured here in such a way that it transforms input-end movement vectors BV into control signals SS at the output end and actuates the drive train 35 with said control signals SS. The drive train 35 can then process these control signals SS, i.e. the components of the drive train 35 are activated by the control signals SS. During a setting down process this means that the steering system 35 automatically carries out the necessary steering instructions.

In addition it is possible to provide for the supports 5 to be retracted automatically by the path computer 8 or by the control device 39 at the end of the picking up process.

If the movement vectors BV which are generated by the path computer 8 comprise not only the steering instructions but also braking instructions and acceleration instructions or velocity instructions, it is also possible to implement an autonomous operating mode of the vehicle combination 1 in which the reverse movement of the vehicle combination 1 for picking up the frame 4 takes place automatically. For this purpose, the vehicle combination 1 is pre-positioned in a suitable way relative to the frame 4 and placed in a special operating mode which permits the frame 4 to be picked up automatically. Within the scope of this operating mode, the actual values for the orientation and position of the frame 4 and of the trailer 3 are then determined and conveyed to the path computer 8 via the input devices 10 and 11. From said values, the path computer 8 determines the reference values for the orientation and position of the trailer 3 and from said reference values the path 6 which contains the necessary movement vectors BV.

According to one particularly advantageous embodiment, the trailer 3 can additionally be equipped with a distance sensor system 40 which comprises one or more distance sensors 41. This distance sensor system 40 then monitors the direct surroundings of the trailer 3 and can determine distance values as the trailer 3 approaches the frame 4. These distance values can be used, on the one hand, by the path computer 8 to adjust the actual values for the orientation and position of the trailer 3 and of the frame 4. The path computer 8 can therefore continuously correct the path 6 using the distance values. In this way it is possible, at least in the close range, to improve the method of functioning of the control system. In addition or alternatively it is possible to provide for the path computer 8 and/or the control unit 39 to monitor the presence of the risk of a collision on the basis of the current distance values. When an acute risk of collision is present, the path computer 8 and/or the control device 39 can then generate a prioritized braking instruction which brings the towing vehicle 2 to a standstill in good time. This emergency braking instruction has priority here over all the instructions of the movement vectors BV of the path 6.

1-14. (canceled)

15. A control system for a vehicle combination composed of a towing vehicle and a trailer for picking up, transporting and setting down a frame which can be positioned on supports and have a payload loaded onto it, said control system comprising:
a path computer which, for picking up the frame, calculates a path that leads the trailer backward under the frame;
a first input device via which an actual position and orientation of the frame can be input into the path computer; and
a second input device via which an actual position and orientation of the trailer can be input into the path computer; wherein
the path computer is configured in such a way that it calculates, from the actual position and orientation of the frame, a reference position and orientation for the trailer in which the trailer is located under the frame in order to pick it up; and
said path computer calculates the path which lads the trailer backward under the frame, based on the actual values and the reference values for the position and orientation of the trailer.

16. The control system as claimed in claim 15, wherein
actual values for position and orientation of the frame are stored electronically in a frame memory of the frame in such a way that they can be read out; and
the first input device or a central memory of a dispatch or logistics center can be connected to the frame memory in order to transmit data.

17. The control system as claimed in claim 16, wherein:
the frame memory is permanently arranged on the frame; and
the first input device or the central memory can be connected to the frame memory to form a telemetric data transmission means.

18. The control system as claimed in claim 16, wherein:
the frame memory is arranged on the frame in a removable fashion; and
the first input device or the central memory is equipped with a suitable interface via which the frame memory can be connected to the first input device or to the central memory in order to transmit data.

19. The control system as claimed in claim 17, wherein:
a dispatch or logistics center contains, in its central memory, the actual positions and actual orientations for all frames positioned on its premises; and
in order to read in the actual position and orientation of the frame to be picked up, the first input device is connectable to the central memory in order to transmit data.

20. The control system as claimed in claim 19, wherein freight information is also stored in the frame memory.

21. The control system as claimed in claim 20, wherein, when the frame is set down, the path computer calculates the actual orientation and position of the frame from the actual position and orientation of the trailer, and stores them in the frame memory.

22. The control system as claimed in claim 21, wherein the second input device has a satellite-supported navigation device and at least one compass which can be read out and which is used to acquire the actual position and orientation of the trailer.

23. The control system as claimed in claim 21, wherein a dispatch or logistics center has a position and orientation determining device which acquires actual values for the orientation and position of the towing vehicle or of the trailer, and can be connected to the second input device in a wire bound or wireless fashion to transmit data.

24. The control system as claimed in claim 22, wherein the second input device has one of a shaft angle sensor and a bending angle sensor, and uses it to determine actual position and orientation of the trailer.

25. The control system as claimed in claim 24, wherein the trailer is embodied as one of a semitrailer, a trailer which can be steered with a steering shaft, and a trailer which is permanently connected to a rigid shaft.

26. The control system as claimed in claim 25, wherein:
the path is composed of a sequence of movement vectors each of which has at least one steering instruction for a steering system of the towing vehicle; and
the path computer calculates the steering instructions in such a way that when the trailer moves backward and follows the steering instructions, it moves under the frame.

27. The control system as claimed in claim 26, wherein a display device that indicates the steering instructions to a driver of the vehicle in one of a visual and an audible fashion, is provided in a cockpit of a towing vehicle.

28. The control system as claimed in claim 27, wherein:
the towing vehicle has a drive train that can be actuated electronically, and comprises at least one steering system that can be activated electronically; and
a control device is provided which generates output control signals based on input movement vectors, and actuates the drive train in such a way that during a reverse movement to pick up the frame, the steering system follows the steering instructions automatically.

29. The control system as claimed in claim 28, wherein:
the drive train also comprises an electrically activatable brake and drive unit;
the movement vector includes braking instructions, and acceleration or velocity instructions; and
control signals of the control device actuate the drive train in such a way that it automatically implements the reverse movement to pick up the frame.

30. The control system as claimed in claim 29, wherein the trailer is equipped with a distance sensor system which, when the trailer approaches the frame determines distance values which can be used by the path computer to correct the path or which are taken into account by the control device or by the path computer in such a way that the control device or the path computer generates a prioritized braking instruction if an acute risk of collision is present.
